(19) United States
(12) Patent Application Publication
(10) Pub. No.: US 2021/0304683 A1
(43) Pub. Date: Sep. 30, 2021

(54) BRIGHTNESS ADJUSTMENT METHOD, DIMMING DEVICE, AND DISPLAY PANEL

(71) Applicant: TCL China Star Optoelectronics Technology Co., Ltd., Shenzhen (CN)

(72) Inventor: Yuntao LI, Shenzhen (CN)

(73) Assignee: TCL China Star Optoelectronics Technology Co., Ltd., Shenzhen (CN)

(21) Appl. No.: 16/626,585

(22) PCT Filed: Dec. 16, 2019
(86) PCT No.: PCT/CN2019/125564

§ 371 Date: Dec. 26, 2019

(30) Foreign Application Priority Data
Dec. 3, 2019 (CN) 201911217315.0

(51) Int. Cl. G09G 3/34; G09G 5/10

(52) U.S. Cl. CPC G09G 3/342; G09G 2320/064; G09G 5/10

(57) ABSTRACT

The present invention provides a brightness adjustment method, a dimming device, and a display panel. The method comprises following steps of: receiving N initial dimming signals, performing a delay processing on at least one initial dimming signal of the N initial dimming signals to obtain N dimming signals, and using the N dimming signals to perform a brightness adjustment on the N dimming regions respectively within a dimming cycle; wherein N≥2, and N is a positive integer. The method can easily eliminate horizontal blocks of the display panel and improve display effects of the display panel.

### FIELD OF INVENTION

The present invention relates to the field of display technologies; and in particular, to a brightness adjustment method, a dimming device, and a display panel.

### BACKGROUND OF INVENTION

At present, for handheld devices and various terminal devices, such as mobile phones, tablets, and laptops, screen brightness is very dazzling even at the lowest level in a dark environment at night. This kind of screen light with high-contrast in the dark environment will cause great irritation and damage to human eye, and it affects surrounding people at the same time.

Currently, dimming adjustments with pulse width modulates (PWM) for backlights of liquid crystal displays (LCDs) have been widely used. Current designs are generally fixed PWM dimming frequencies, whose frequencies are set to an integer multiple of a refresh rate of an LCD screen, and brightness is adjusted by adjusting a duty cycle. However, since all PWM dimming signals are switched from high to low and from low to high, which are aligned, in this design, when strong light is irradiated, that is, when PWM is high, about tens of lines of the strong light are irradiated, pixel capacitances will change, so that charged electric charges are different from charged electric charges in hundreds of lines during no-light periods, which will cause horizontal blocks to appear in grayscale pictures of LCD and affecting display effects of display panels.

### SUMMARY OF INVENTION

The invention is directed to a brightness adjustment method in the prior art, which has problems that horizontal blocks appear on pictures of a display panel and affect display effects of the display panel, and thus a brightness adjustment method, a dimming device, and a display panel are provided.

In a first aspect, the present invention provides a brightness adjustment method used for a display panel, wherein the display panel comprises a backlight source having N LED strings, and the method comprises following steps of:

receiving N initial dimming signals, wherein the N initial dimming signals control N dimming regions respectively;

performing a delay processing on at least one initial dimming signal of the N initial dimming signals to obtain N dimming signals, wherein each of the N dimming signals comprises a pulse width in at least two periods in a frame scanning period, and the at least one initial dimming signal excludes the first one of the N initial dimming signals; and

using the N dimming signals to perform brightness adjustment on the N dimming regions respectively within a dimming cycle;

wherein N≥2, and N is a positive integer.

Further, the step of receiving the N initial dimming signals comprises:

receiving the N initial dimming signals from the display panel through the backlight source.

Further, the step of performing the delay processing on the at least one initial dimming signal of the N initial dimming signals to obtain the N dimming signals comprises:

delaying the at least one initial dimming signal of the N initial dimming signals by a first default time to obtain a first dimming signal, wherein the first dimming signal excludes the first one of the N initial dimming signals; and

obtaining the N dimming signals according to the first dimming signal and initial dimming signals other than an initial dimming signal corresponding to the first dimming signal in the at least one initial dimming signal.

Further, the step of using the N dimming signals to perform the brightness adjustment on the N dimming regions respectively within the dimming cycle comprises:

using the N dimming signals to sequentially charge the N LED strings within the dimming cycle.

Further, the N initial dimming signals are pulse signals with the same period and duty cycle.

Further, the step of performing the delay processing on the at least one initial dimming signal of the N initial dimming signals to obtain the N dimming signals comprises:

sequentially delaying the N initial dimming signals by a second default time to obtain the N dimming signals.

Further, the step of using the N dimming signals to perform the brightness adjustment on the N dimming regions respectively within the dimming cycle comprises:

performing the brightness adjustment on the N dimming regions in sequence by using the N dimming signals every second default time.

Further, the N initial dimming signals are pulse signals with different periods.

Further, the step of performing the delay processing on the at least one initial dimming signal of the N initial dimming signals to obtain the N dimming signals comprises:

delaying M PWM initial dimming signals of N PWM initial dimming signals by the first default time to obtain a second PWM initial dimming signal, wherein a second PWM dimming signal comprises the M PWM initial dimming signals;

wherein N PWM dimming signals are formed by the second PWM dimming signal, the at least one PWM initial dimming signals except the PWM initial dimming signal corresponding to the second PWM dimming signal, and the first one of the N initial dimming signals;

wherein M is a positive integer, and 2≤M≤N−1.

In a second aspect, the present invention further provides a dimming device used for a display panel. The dimming device comprises:

a receiving module receiving N initial dimming signals, wherein the N initial dimming signals respectively control N dimming regions correspondingly;

a delay module performing a delay processing on the N initial dimming signals to obtain N dimming signals after the delay processing; and

a driving module, which uses the N dimming signals to perform a brightness adjustment on the N dimming regions in a dimming cycle.

Further, the receiving module is used for receiving the N initial dimming signals from the display panel through a backlight source.

Further, the delay module is used for delaying at least one initial dimming signal of the N initial dimming signals by a first default time to obtain a first dimming signal, wherein the first dimming signal excludes the first one of the N initial dimming signals; and

obtaining N dimming signals according to the first dimming signal and initial dimming signals other than an initial dimming signal corresponding to the first dimming signal in the at least one initial dimming signal.

Further, the driving module is used for sequentially charging N LED strings by the N dimming signals in the dimming cycle.

Further, the N initial dimming signals are pulse signals with the same period and duty cycle.

Further, the delay module is used for sequentially delaying the N initial dimming signals by a second default time to obtain the N dimming signals.

Further, the driving module is used for performing a brightness adjustment on the N dimming regions in sequence by using the N dimming signals every second default time.

Further, the N initial dimming signals are pulse signals with different periods.

In a third aspect, the present invention further provides a display panel comprising a dimming device. The dimming device comprises:

a receiving module receiving N initial dimming signals, wherein the N initial dimming signals respectively control N dimming regions correspondingly;

a delay module performing a delay processing on the N initial dimming signals to obtain N dimming signals after the delay processing; and

a driving module, which uses the N dimming signals to perform a brightness adjustment on the N dimming regions in a dimming cycle.

Further, the receiving module is used for receiving the N initial dimming signals from the display panel through a backlight source.

Further, the delay module is used for delaying at least one initial dimming signal of the N initial dimming signals by a first default time to obtain a first dimming signal, wherein the first dimming signal excludes the first one of the N initial dimming signals; and

obtaining the N dimming signals according to the first dimming signal and initial dimming signals other than an initial dimming signal corresponding to the first dimming signal in the at least one initial dimming signal.

The beneficial effects of the present invention are: the brightness adjustment method provided by the invention comprises the steps of: performing the delay processing on the at least one initial dimming signal excludes the first one of the N initial dimming signals in the dimming cycle through the N initial dimming signals received by the display panel to obtain the N dimming signals, and charging the display panel by using the N dimming signals, so that the display panel is not provided with relative strong light and weak light stages when being charged, chances of light irradiation of pixel capacitors corresponding to horizontal block regions of the display panel are equal, the charging effects are the same under the same grayscale pictures, the horizontal blocks of the display panel are eliminated, and the display effects of the display panel is improved.

### DESCRIPTION OF DRAWINGS

The following detailed description of specific embodiments of the present invention will make the technical solution and other beneficial effects of the present invention obvious in conjunction with the accompanying drawings.

FIG. 1 is a schematic flowchart of an embodiment of a brightness adjustment method provided by the present invention.

FIG. 2 is a schematic view of the embodiment of the brightness adjustment method provided by the present invention.

FIG. 3 is a schematic view of an embodiment of a dimming device provided by the present invention.

### DETAILED DESCRIPTION OF PREFERRED EMBODIMENTS

The technical solution in the embodiments of the present invention will be clearly and completely described below with reference to the accompanying drawings in the embodiments of the present invention. It is to be understood that the described embodiments are merely exemplary of the invention, and not restrictive of the full scope of the invention. All other embodiments, which can be obtained by a person skilled in the art without inventive step based on the embodiments of the present invention, are within the scope of the present invention.

In the description of the present invention, it is to be understood that the terms “center,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” and the like are used in the orientations and positional relationships indicated in the drawings for convenience in describing the present invention and for simplicity in description, and are not intended to indicate or imply that the referenced devices or elements must have a particular orientation, be constructed in a particular orientation, and be operated in a particular manner, and are not to be construed as limiting the present invention. Further, the terms “first” and “second” are used for descriptive purposes only and are not to be construed as indicating or implying relative importance or implicitly indicating the number of technical features indicated. Thus, features defined as “first”, “second”, may explicitly or implicitly include one or more of the described features. In the description of the present invention, “plurality” means two or more unless specifically limited otherwise.

In the description of the present invention, it is to be noted that, unless otherwise explicitly specified or limited, the terms “mounted,” “connected,” and “linked” are to be construed broadly, e.g., as meaning either a fixed connection, a removable connection, or an integral connection; may be mechanically connected, may be electrically connected or may be in communication with each other; either directly or indirectly through intervening media, either internally or in any other relationship. The specific meaning of the above terms in the present invention can be understood by those of ordinary skill in the art as appropriate.

In the present invention, unless otherwise specifically defined and defined, the first feature is “on” or “under” the second feature may include that the first feature is in direct contact to the second feature, and may also include that the first feature and the second feature are not in direct contact but through additional features between them. Moreover, the first feature is “on,” “above,” and “under” the second feature includes the first feature is directly above and obliquely above the second feature, or merely indicating that the high of the first feature is higher than the second feature. The first feature is “below,” “under,” and “lower” the second feature includes the first feature is directly below and obliquely below the second feature, or merely indicating that the high of the first feature is less than the second feature.

The following disclosure provides many different embodiments or examples for implementing different features of the invention. In order to simplify the disclosure of the present invention, specific example components and arrangements are described below. Of course, they are merely examples and are not intended to limit the present invention. Moreover, the present invention may repeat reference numerals and/or letters in the various examples, such repetition is for the purpose of simplicity and clarity and does not in itself dictate a relationship between the various embodiments and/or configurations discussed. In addition, examples of various specific processes and materials are provided herein, but one of ordinary skill in the art may recognize applications of other processes and/or uses of other materials.

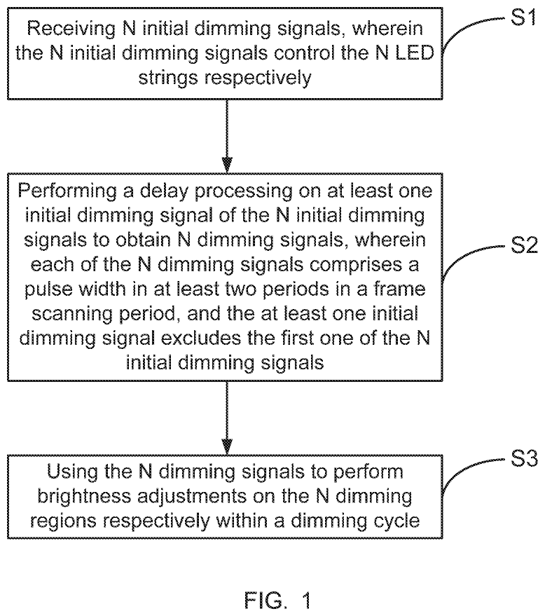

The present invention provides a brightness adjustment method used for a display panel. The display panel comprises a backlight source having N LED strings. As shown in FIG. 1, which is a schematic flowchart of an embodiment of the brightness adjustment method provided by the present invention. The brightness adjustment method comprises following steps of:

S1: receiving N initial dimming signals, wherein the N initial dimming signals control the N LED strings respectively.

S2: performing a delay processing on at least one initial dimming signal of the N initial dimming signals to obtain N dimming signals, wherein each of the N dimming signals comprises a pulse width in at least two periods in a frame scanning period, and the at least one initial dimming signal excludes the first one of the N initial dimming signals.

S3: using the N dimming signals to perform brightness adjustments on the N dimming regions respectively within a dimming cycle.

wherein N≥2, and N is a positive integer.

The brightness adjustment method of the present invention, by performing the delay processing on the at least one initial dimming signal excludes the first one of the N initial dimming signals in the dimming cycle through the N initial dimming signals received by the display panel to obtain N dimming signals, and charging the display panel by using the N dimming signals, so that the display panel is not provided with relative strong light and weak light stages when being charged, chances of light irradiation of pixel capacitors corresponding to horizontal block regions of the display panel are equal, charging effects are the same under the same grayscale pictures, thus horizontal blocks of the display panel are eliminated, and display effects of the display panel are improved.

In some embodiments of the present invention, the initial dimming signal may be a pulse width modulate (PWM) dimming signal, and periods and pulse ratios of the N initial dimming signals are the same.

Based on the above embodiments, the backlight source of the display panel comprises the N LED strings. The N LED strings receive N PWM initial dimming signals, and the N PWM initial dimming signals respectively control the N LED strings. That is, the N PWM initial dimming signals correspond to the N LED strings. The N PWM initial dimming signals are PWM1, PWM2, PWM3, etc. It can be understood that PWM1 is the first dimming signal in the N PWM initial dimming signals.

It should be noted that in the embodiment of the present invention, N≥2. That is, the number of the LEDs and the number of the PWM initial dimming signals are both greater than or equal to 2.

In the embodiment of the present invention, there may be a plurality of ways of receiving the N PWM initial dimming signals. In an embodiment of the present invention, the display panel of the embodiment of the present invention comprises a PWM dimming signal generating device. Wherein, the step of receiving the N PWM initial dimming signals may comprises: receiving the N PWM initial dimming signals from the display panel through the backlight source. Specifically, the backlight source on the display panel receives the N PWM initial dimming signals sent from the PWM dimming signal device of the display panel. In other embodiments of the present invention, the PWM dimming signal device may not be provided in the display panel. That is, the PWM dimming signal device is disposed outside the display panel. Wherein, the step of receiving the N PWM initial dimming signals may comprises: receiving the N PWM initial dimming signals sent from an external PWM dimming signal device through the backlight source disposed on the display panel.

In other embodiments of the present invention, the step of performing the delay processing on the at least one initial dimming signal of the N initial dimming signals to obtain the N dimming signals may comprises:

delaying the at least one PWM initial dimming signal of the N PWM initial dimming signals by a first default time to obtain a first PWM dimming signal, wherein the first PWM dimming signal excludes the first one of the N PWM initial dimming signals (that is. does not include PWM1); and

obtaining the N PWM dimming signals according to the first PWM dimming signal and PWM initial dimming signals other than a PWM initial dimming signal corresponding to the first PWM dimming signal in the at least one PWM initial dimming signal.

Since the N PWM initial dimming signals correspond to control the N LED strings, at least one PWM initial dimming signal excluding PWM1 in the N PWN initial dimming signals is delayed for the first default time to obtain the first PWM dimming signal. The first PWM dimming signal does not comprise the first PWM initial dimming signal in the N PWM initial dimming signals. That is, it does not comprise PWM1.

In a specific embodiment of the present invention, if a period of the N PWM initial dimming signals is T, the delaying of the first default time may be (1/N)*T. That is, the delayed PWM initial dimming signal is delayed compared to the previous PWM initial dimming signal with (1/N)*T, wherein N is the number of PWM initial dimming signals, and T is a period of N PWM initial dimming signals.

In the embodiment of the present invention, any one of the N−1 PWM initial dimming signals other than PWM1 of the N PWM initial dimming signals may be delayed for the first default time to obtain the first PWM dimming signal. Wherein, the first PWM dimming signal only comprises one delayed PWM initial dimming signal.

Wherein, there are N−2 PWM initial dimming signals in addition to the initial PWM dimming signal corresponding to the first PWM dimming signal in the at least one PWM initial dimming signal. The N PWM dimming signals are formed by three signals, which are PWM1 in the N PWM initial dimming signals, the first PWM dimming signal, and the N−2 PWMs in the at least one PWM initial dimming signal except for the initial PWM dimming signal corresponding to the first PWM dimming signal.

In the dimming cycle, the N LED strings are sequentially charged by using the above N PWM dimming signals. The N PWM dimming signals correspond to the N LED strings. In the N PWM dimming signals, there is a PWM dimming signal obtained by delaying the initial PWM dimming signal for the first default time. Therefore, when the N LED strings are charged, the low-light period during an original charging process is enhanced, so that the pixel capacitors in the display panel are more likely to be illuminated, thereby eliminating the horizontal blocks of the display panel and improving the display effect of the display panel.

It should be noted that in the above-mentioned embodiments of the present invention, the N PWM initial dimming signals are pulse signals with the same period and duty cycle.

In other embodiments of the present invention, the step of performing the delay processing on the at least one initial dimming signal of the N initial dimming signals to obtain the N dimming signals comprises:

delaying M PWM initial dimming signals of the N PWM initial dimming signals by the first default time to obtain a second PWM dimming signal, wherein the second PWM dimming signal at this time does not comprise the PWM1 in the N PWM initial dimming signals, and the second PWM dimming signal comprises the M PWM initial dimming signals;

wherein the N PWM dimming signals are formed by the second PWM dimming signal, the at least one PWM initial dimming signals except the PWM initial dimming signal corresponding to the second PWM dimming signal, and the first one of the N initial dimming signals;

In the above embodiments, M is a positive integer, and 2≤M≤N−1. Specifically, M may be a positive integer such as 2, 3, or 4.

In a specific embodiment of the present invention, M may be 2. Wherein, in the at least one PWM initial dimming signal, in addition to the initial PWM dimming signal corresponding to the second PWM dimming signal, there are N−3 PWM initial dimming signals. The N PWM dimming signals are formed by three signals, which are the PWM1 in the N PWM initial dimming signals, the second PWM dimming signal, and the N−3 PWMs in the at least one PWM initial dimming signal except for the initial PWM dimming signal corresponding to the second PWM dimming signal.

It should be noted that in the above embodiment, 3≤N. The two delayed PWM initial dimming signals are delayed by the same time. That is, both are delayed by a third default time.

In some embodiments of the present invention, the third default time and the first default time may be the same or different, and the third default time may be continuously adjusted according to sizes of the horizontal blocks of the display panel.

After obtaining the N PWM dimming signals, use the N PWM dimming signals to sequentially charge the N LED strings, wherein the N PWM dimming signals correspond to N LED strings. There are any two PWM dimming signals obtained by delaying the first PWM dimming signal for the first default time in the N PWM dimming signals. Thus, in the process of charging the N LED strings, a low-light period of the display panel's original charging process has been further enhanced, which increases a chance of the pixel capacitances of the display panel to be illuminated, thereby eliminating the horizontal blocks of the display panel and improving the display effect of the display panel.

On the basis of the above embodiment, if M=2, that is, two of the N−1 PWM initial dimming signals other than PWM1 are delayed, then the delay time of the two PWM initial dimming signals can be different. That is, the two delayed PWM initial dimming signals are delayed by T1 and T2 respectively, so that a third PWM dimming signal is obtained. Wherein, the N PWM dimming signals are formed by three signals, which are the PWM1 in the N PWM initial dimming signals, the third PWM dimming signal, and the N−3 PWM initial dimming signals other than the initial PWM dimming signal corresponding to the third PWM dimming signal in the at least one PWM initial dimming signal.

After obtaining the N PWM dimming signals, use the N PWM dimming signals to sequentially charge the N LED strings. There are any two PWM dimming signals in the N PWM dimming signals which are obtained by the initial PWM dimming signals delayed by T1 and T2 respectively, wherein T1 and T2 are different in time, and can be continuously adjusted with the sizes of the blocks of the display panel. Therefore, in the process of charging the N LED strings, a low-light period of the display panel's original charging process has been further enhanced, which increases a chance of the pixel capacitances of the display panel to be illuminated, thereby eliminating the horizontal blocks of the display panel and improving the display effect of the display panel.

In other embodiments of the present invention, the step of performing the delay processing on the at least one initial dimming signal of the N initial dimming signals to obtain the N dimming signals further comprises:

sequentially delaying the N initial dimming signals by a second default time to obtain the N dimming signals.

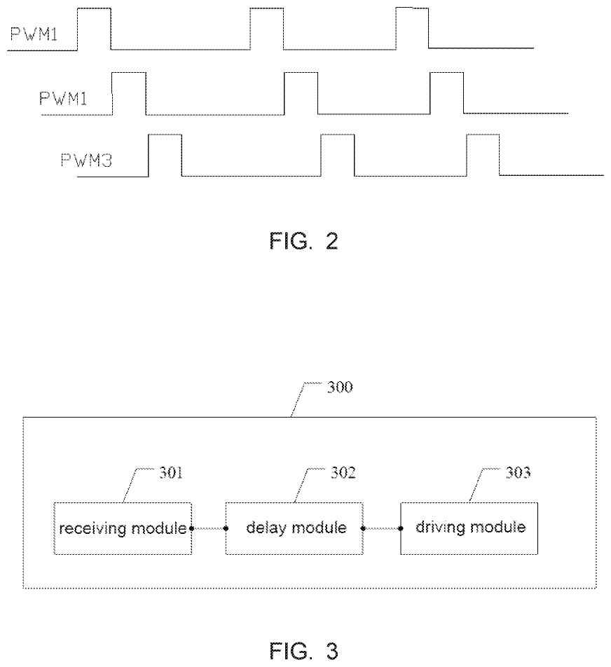

As shown in FIG. 2, which is a schematic view of the embodiment of the brightness adjustment method provided in the present invention. Specifically, starting from the second PWM dimming signal of the N PWM initial dimming signals, the N−1 PWM initial dimming signals may be sequentially delayed for the second default time. Assume that PWM2 is a PWM initial dimming signal after PWM1, and PWM3 is a PWM initial dimming signal after PWM2, that is, PWM2 is delayed the second default time compared to PWM1, and PWM3 is delayed the second default time compared to PWM2, and so on. That is, the current PWM initial dimming signal is delayed by the second default time from the previous PWM initial dimming signal of the current PWM initial dimming signal.

In a specific embodiment of the present invention, if the period of the N PWM initial dimming signals is T, delay the second default time may be (1/N)*T. That is, the delayed PWM initial dimming signal is delayed (1/N)*T from the previous PWM initial dimming signal, where N is the number of PWM initial dimming signals and T is the number of N cycle.

The N PWM initial dimming signals are sequentially delayed for the second default time to obtain the N PWM dimming signals, and the N PWM initial dimming signals are used to charge the N LED strings in a dimming period.

Specifically, the N LED strings are sequentially charged using the N PWM dimming signals every second default time.

It should be noted that in the above embodiment, the N PWM initial dimming signals are pulse signals with the same period and duty cycle.

In other embodiments of the present invention, the N PWM initial dimming signals may also be pulse signals with different periods or duty cycles.

Specifically, in a specific embodiment of the present invention, if the period of PWM2 is N times of PWM1, and N≥2, during the weak light period of the PWM1 charge, there is a strong light period of the PWM2 when the LED is being charged. This reduces the weak light period of the display panel, and the pixel capacitors corresponding to regions of the horizontal blocks of the display panel are equally exposed to light. Under the same grayscale picture, the charging effect is the same, thereby eliminating the horizontal blocks of the display panel and improving the display effects of the display panel.

In addition, in other embodiments of the present invention, the duty cycle of PMW2 may be M times of PWM1, and M≥2. When the display panel is being charged, the duty ratio of PWM1 is greater than PWM1, so that during the low-light period of PWM1, the pixel capacitances corresponding to the regions of the horizontal blocks of the display panel are still illuminated by light. Furthermore, the charging effect is the same under the same grayscale picture, thereby eliminating horizontal blocks of the display panel and improving the display effects of the display panel.

The present invention further provides a dimming device used for a display panel. The display panel comprises a backlight source, and the backlight source comprises N LED strings. As shown in FIG. 3, a schematic view of an embodiment of the dimming device is provided for the present invention. The dimming device 300 comprises:

a receiving module 301 receiving N initial dimming signals, wherein the N initial dimming signals respectively control the N LED strings correspondingly;

a delay module 302 performing a delay processing on the N initial dimming signals to obtain N dimming signals after the delay processing; and

a driving module 303, which uses the N dimming signals to perform a brightness adjustment on the N dimming regions in a dimming cycle.

The dimming device provided by the invention, by performing the delay processing on the at least one initial dimming signal excludes the first one of N initial dimming signals in the dimming cycle through the N initial dimming signals received by the display panel to obtain the N dimming signals, and charging the display panel by using the N dimming signals, so that the display panel is not provided with relative strong light and weak light stages when being charged, chances of light irradiation of pixel capacitors corresponding to regions of horizontal blocks of the display panel are equal, charging effects are the same under the same gray scale pictures, the horizontal blocks of the display panel are eliminated, and display effects of the display panel is improved.

In some embodiments of the present invention, the receiving module 301 may be specifically configured to receive the N initial dimming signals from the display panel through the backlight source.

The delay module 302 may be specifically used for: delaying at least one initial dimming signal of the N initial dimming signals by a first default time to obtain a first dimming signal, wherein the first dimming signal excludes the first one of the N initial dimming signals; and obtaining the N dimming signals according to the first dimming signal and initial dimming signals other than an initial dimming signal corresponding to the first dimming signal in the at least one initial dimming signal.

In some embodiments of the present invention, the driving module 303 may be specifically configured to: in the dimming cycle, use the N dimming signals to sequentially charge the N LED strings.

In the above embodiment, the N initial dimming signals are pulse signals with the same period and duty ratio.

In other embodiments of the present invention, the delay module 302 may be specifically configured to delay the N initial dimming signals in sequence by a second default time to obtain the N dimming signals. The driving module 303 may be specifically configured to perform brightness adjustments on the N dimming regions in sequence by using the N dimming signals every second default time.

In the above embodiment, the N initial dimming signals are pulse signals with different periods.

The present invention further provides a display panel comprising the above-mentioned dimming device. The display panel provided by the invention, by performing the delay processing on the at least one initial dimming signal excludes the first one of N initial dimming signals in the dimming cycle through the N initial dimming signals received by the display panel to obtain the N dimming signals, and charging the display panel by using the N dimming signals, so that the display panel is not provided with relative strong light and weak light stages when being charged, chances of light irradiation of pixel capacitors corresponding to regions of horizontal blocks of the display panel are equal, charging effects are the same under the same gray scale pictures, the horizontal blocks of the display panel are eliminated, and display effects of the display panel are improved.

In the above embodiments, the description of each embodiment has its own emphasis. For a part that is not described in detail in one embodiment, refer to the description of other embodiments.

The brightness adjustment method, the dimming device, and the display panel provided by the embodiments of the present invention have been described in detail above. In the above, various other corresponding changes and modifications can be made according to the technical solutions and technical ideas of the present invention to those skilled in the art, and all such changes and modifications are within the scope of the claims of the present invention.

What is claimed is:

1. A brightness adjustment method, used for a display panel, wherein the display panel comprises a backlight source having N LED strings, the method comprising following steps of:
receiving N initial dimming signals, wherein the N initial dimming signals control N dimming regions respectively;
performing a delay processing on at least one initial dimming signal of the N initial dimming signals to obtain N dimming signals, wherein each of the N dimming signals comprises a pulse width in at least two periods in a frame scanning period, and the at least one initial dimming signal excludes the first one of the N initial dimming signals; and
using the N dimming signals to perform brightness adjustments on the N dimming regions respectively within a dimming cycle;
wherein N≥2, and N is a positive integer.

2. The brightness adjustment method as claimed in claim 1, wherein the step of receiving the N initial dimming signals comprises:
receiving the N initial dimming signals from the display panel through the backlight source.

3. The brightness adjustment method as claimed in claim 1, wherein the step of performing the delay processing on the at least one initial dimming signal of the N initial dimming signals to obtain the N dimming signals comprises:
delaying the at least one initial dimming signal of the N initial dimming signals by a first default time to obtain a first dimming signal, wherein the first dimming signal excludes the first one of the N initial dimming signals; and
obtaining the N dimming signals according to the first dimming signal and initial dimming signals other than an initial dimming signal corresponding to the first dimming signal in the at least one initial dimming signal.

4. The brightness adjustment method as claimed in claim 3, wherein the step of using the N dimming signals to perform the brightness adjustment on the N dimming regions respectively within the dimming cycle comprises:
using the N dimming signals to sequentially charge the N LED strings within the dimming cycle.

5. The brightness adjustment method as claimed in claim 3, wherein the N initial dimming signals are pulse signals with the same period and duty cycle.

6. The brightness adjustment method as claimed in claim 1, wherein the step of performing the delay processing on the at least one initial dimming signal of the N initial dimming signals to obtain the N dimming signals comprises:
sequentially delaying the N initial dimming signals by a second default time to obtain the N dimming signals.

7. The brightness adjustment method as claimed in claim 6, wherein the step of using the N dimming signals to perform the brightness adjustment on the N dimming regions respectively within the dimming cycle comprises:
performing the brightness adjustment on the N dimming regions in sequence by using the N dimming signals every second default time.

8. The brightness adjustment method as claimed in claim 7, wherein the N initial dimming signals are pulse signals with different periods.

9. The brightness adjustment method as claimed in claim 1, wherein the step of performing the delay processing on the at least one initial dimming signal of the N initial dimming signals to obtain the N dimming signals comprises:
delaying M PWM initial dimming signals of N PWM initial dimming signals by the first default time to obtain a second PWM initial dimming signal, wherein a second PWM dimming signal comprises the M PWM initial dimming signals;
wherein N PWM dimming signals are formed by the second PWM dimming signal, the at least one PWM initial dimming signals except the PWM initial dimming signal corresponding to the second PWM dimming signal, and the first one of the N initial dimming signals;
wherein M is a positive integer, and 2≤M≤N−1.

10. A dimming device used for a display panel, comprising:
a receiving module receiving N initial dimming signals, wherein the N initial dimming signals respectively control N dimming regions correspondingly;
a delay module performing a delay processing on the N initial dimming signals to obtain N dimming signals after the delay processing; and
a driving module, which uses the N dimming signals to perform a brightness adjustment on the N dimming regions in a dimming cycle.

11. The dimming device as claimed in claim 10, wherein the receiving module is used for receiving the N initial dimming signals from the display panel through a backlight source.

12. The dimming device as claimed in claim 10, wherein the delay module is used for delaying at least one initial dimming signal of the N initial dimming signals by a first default time to obtain a first dimming signal, wherein the first dimming signal excludes the first one of the N initial dimming signals; and
obtaining N dimming signals according to the first dimming signal and initial dimming signals other than an initial dimming signal corresponding to the first dimming signal in the at least one initial dimming signal.

13. The dimming device as claimed in claim 12, wherein the driving module is used for sequentially charging N LED strings by the N dimming signals in the dimming cycle.

14. The dimming device as claimed in claim 12, wherein the N initial dimming signals are pulse signals with the same period and duty cycle.

15. The dimming device as claimed in claim 10, wherein the delay module is used for sequentially delaying the N initial dimming signals by a second default time to obtain the N dimming signals.

16. The dimming device as claimed in claim 15, wherein the driving module is used for performing a brightness adjustment on the N dimming regions in sequence by using the N dimming signals every second default time.

17. The dimming device as claimed in claim 15, wherein the N initial dimming signals are pulse signals with different periods.

18. A display panel, comprising:
a dimming device, wherein the dimming device comprises:
a receiving module receiving N initial dimming signals, wherein the N initial dimming signals respectively control N dimming regions correspondingly;
a delay module performing a delay processing on the N initial dimming signals to obtain N dimming signals after the delay processing; and
a driving module, which uses the N dimming signals to perform a brightness adjustment on the N dimming regions in a dimming cycle.

19. The display panel as claimed in claim 18, wherein the receiving module is used for receiving the N initial dimming signals from the display panel through a backlight source.

20. The display panel as claimed in claim 18, wherein the delay module is used for delaying at least one initial dimming signal of the N initial dimming signals by a first default time to obtain a first dimming signal, wherein the first dimming signal excludes the first one of the N initial dimming signals; and
obtaining the N dimming signals according to the first dimming signal and initial dimming signals other than an initial dimming signal corresponding to the first dimming signal in the at least one initial dimming signal.
